(19) United States
(12) Patent Application Publication
(10) Pub. No.: US 2006/0091702 A1
(43) Pub. Date: May 4, 2006

(54) Multi-piece hardtop with stackable storage trays for a sport utility vehicle

(76) Inventor: Richard C. Essig, Berthoud, CO (US)

Correspondence Address: W.SCOTT CARSON, ESQ;DORR CARSON SLOAN & BIRNEY, PC, 3010 EAST 6TH AVENUE, DENVER, CO, 80206, US

(21) Appl. No.: 10/978,071

(22) Filed: Oct. 28, 2004

(51) Int. Cl. B60J 7/08

(52) U.S. Cl. 296/218

(57) ABSTRACT

A multi-piece hardtop (1) for a sport utility vehicle (4). The hardtop (1) has a front roof section (3) with a storage tray (7) mounted on it and a rear roof section (5) with a storage tray (9) on it. In use, the front roof section (3) and its storage tray (7) can be arranged in a first position over the front or cockpit area (2) to enclose the vehicle (4). Additionally, the front roof section (3) and its storage tray (7) can be completely removed from the vehicle (4) and mounted in a second position over the rear roof section (5) and its storage tray (9). In the second position, the vehicle occupants can enjoy an open air experience with the front and rear storage trays (7,9) and roof sections (3,5) being stacked in a neat and compact manner on the vehicle (4).

### BACKGROUND OF THE INVENTION

1. Field of the Invention

This invention relates to the field of hardtops for sport utility vehicles and more particularly to the field of multi-piece hardtops for such vehicles.

2. Discussion of the Background

Sport utility vehicles with removable hardtops are very popular. With them, the vehicle occupants can enjoy an open air experience yet be able to completely enclose the vehicle if desired or needed should the weather change. In such vehicles, carrying or storage space for gear and other items for camping, hunting, and the like is normally at a premium. In this regard, it is quite common to store as much gear as possible inside as well as outside on the vehicle. However, combining the features of a removable roof section for an open air experience and convenient storage capacity can present many design challenges.

Among them is the challenge to make a hardtop with readily accessible, exterior storage capacity yet one that will also permit at least one section of the roof (e.g., over the cockpit) to be removed so the occupants can enjoy the open air experience. A further challenge is to do so in a manner that allows the removed cockpit cover to be carried on the vehicle should it be desired or needed again to enclose the vehicle. This is in contrast to having to leave the removed roof section, for example, at home or having to carry it inside the vehicle where it would take up valuable space. In some smaller vehicles, the removed roof section many not even fit inside.

In commonly owned U.S. Pat. Nos. 5,725,273 and 6,309,007, hardtop assemblies are disclosed in which the front roof section over the cockpit can be completely removed and carried on the rear roof section of the vehicle. The present invention is an improvement over these commonly owned patents and offers increased storage capacity with storage trays being provided over both the front and rear roof sections of the hardtop. Additionally, the completely removable front section with its storage tray can be easily and quickly positioned over the rear roof section above its storage tray. In this position, the front roof section and its storage tray are then stacked above the rear storage tray in a neat and compact manner yet readily available to be re-positioned over the vehicle cockpit if necessary.

### SUMMARY OF THE INVENTION

This invention involves a multi-piece hardtop for a sport utility vehicle. The hardtop has a front roof section with a storage tray mounted on it and a rear roof section with a storage tray on it. In use, the front roof section and its storage tray can be arranged in a first position over the front or cockpit area to enclose the vehicle. Additionally, the front roof section and its storage tray can be completely removed from the vehicle and mounted in a second position over the rear roof section and its storage tray.

In the second position, the vehicle occupants can enjoy an open air experience with the front and rear storage trays and roof sections being stacked in a neat and compact manner on the vehicle. Further, and to the extent any gear carried in the rear storage tray does not stick up too far, it can simply remain in place regardless of the positioning of the front roof section. Should the weather change or it otherwise be desirable, the front roof section and its storage tray can be quickly and easily re-mounted over the cockpit area to again enclose the vehicle. Whether the front roof section is positioned over the cockpit area or the rear roof section, any carried items in the front storage tray need not be removed and can conveniently stay in place.

### BRIEF DESCRIPTION OF THE DRAWINGS

FIG. 1 is a perspective view of the multi-piece hardtop of the present invention with the front roof section positioned over the cockpit area to enclose the vehicle.

FIG. 2 is a side elevational view of the multi-piece hardtop of FIG. 1.

FIG. 3 is a side elevational view of the multi-piece hardtop of the present invention with the front roof section and its storage tray positioned above the rear roof section and its storage tray.

FIG. 4 is a view illustrating the manner in which the front roof section is removably attached to the vehicle over the cockpit area.

FIG. 5 is an enlarged view of one of the clamps removably securing the front roof section to the vehicle windshield.

FIG. 6 is a perspective view of the front and rear roof sections and the storage trays mounted on them.

FIG. 7 is an enlarged view of the manner in which the front storage tray is mounted to the rack on the front roof section.

FIG. 8 is an enlarged and partially exploded view of one of the flanges on the rack of the rear roof section to which the front roof section can be removably attached.

FIGS. 9 is a plan view of the underside of the front roof section.

FIG. 10 is a view taken along line 10-10 of FIG. 9 illustrating one of the members for attaching the front roof section over the rear roof section.

FIGS. 11-13 sequentially illustrate how the front roof section is removably attached over the rear roof section.

FIG. 11a is an enlarged view of the left side of FIG. 11.

FIG. 14 is an enlarged view taken along line 14-14 of FIG. 13.

### DETAILED DESCRIPTION OF THE INVENTION

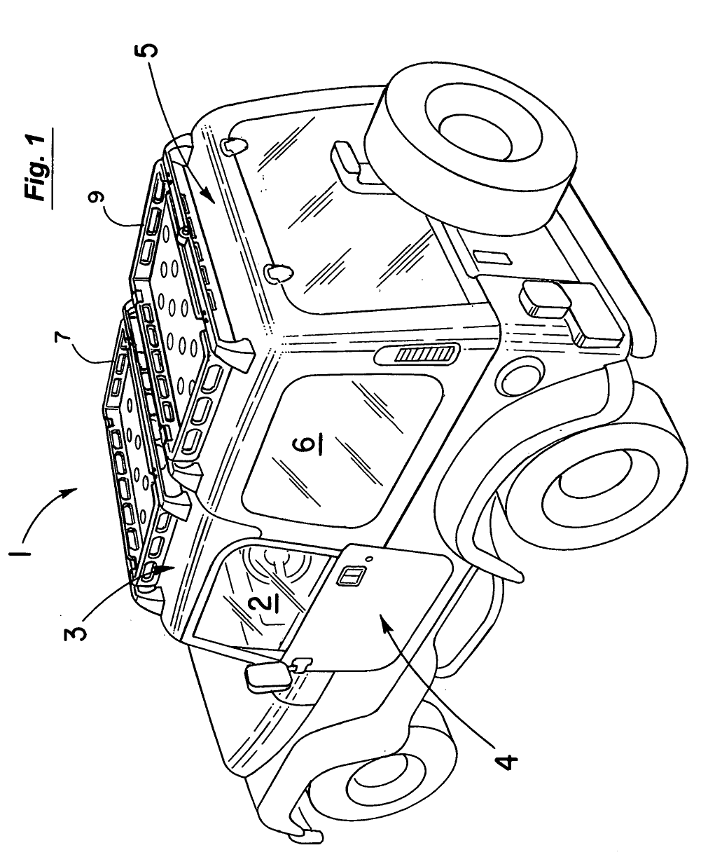

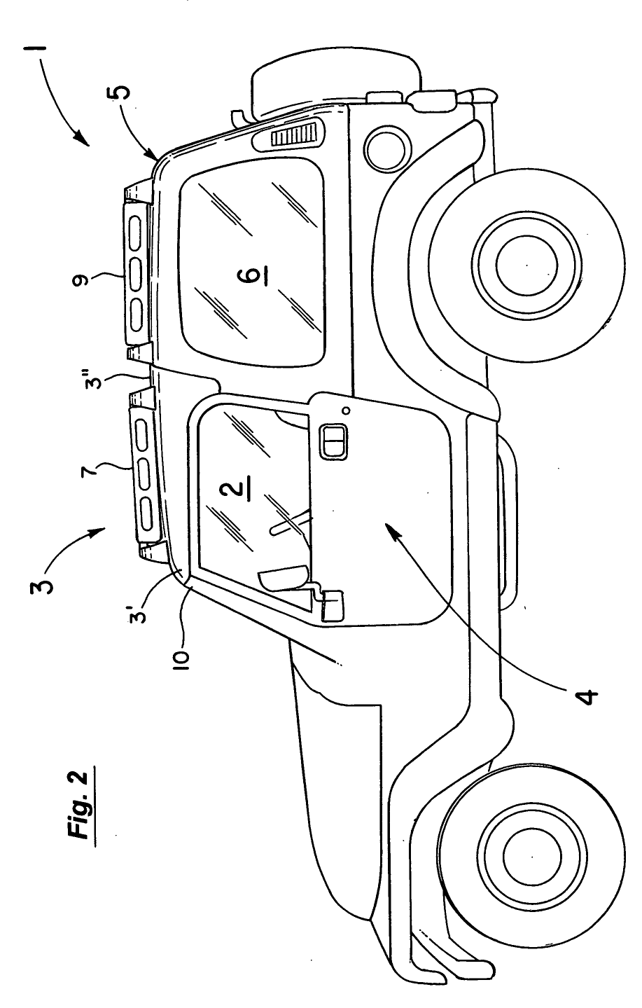

As shown in FIGS. 1 and 2, the multi-piece hardtop 1 of the present invention includes front and rear roof sections 3 and 5. The front roof section 3 as illustrated in FIGS. 1 and 2 is positioned over the forward area or cockpit 2 of the sport utility vehicle 4 where the driver and front passengers would normally sit. The rear roof section 5 in turn is positioned over the rearward area 6 of the vehicle 4. Each of the front and rear roof sections 3 and 5 as illustrated has a storage tray 7 and 9 mounted thereon.

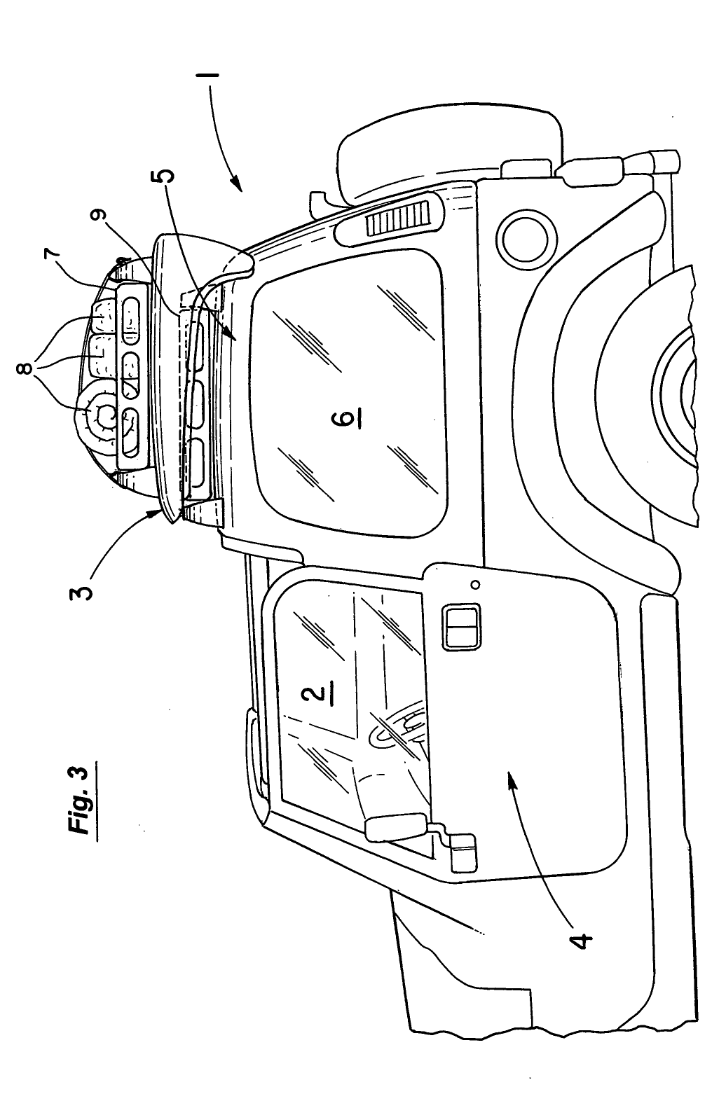

In use, the front roof section 3 with the front storage tray 7 mounted thereon can be attached in a first position (FIGS. 1 and 2) above the forward area 2 of the vehicle 4. In this location, the entire interior of the vehicle 4 is then enclosed. Additionally, the front roof section 3 with the front storage tray 7 can be removed and attached in a second position (FIG. 3) to the rear roof section 5 above the rear storage tray 9. In the position of FIG. 3, the front storage tray 7 of the front roof section 3 is then stacked above the rear storage tray 9 in a neat and compact manner. The driver and passengers can thus enjoy the open air experience of FIG. 3 yet the front roof section 3 and its storage tray 7 can be quickly and easily re-mounted as in FIGS. 1 and 2 whenever desired or needed as should the weather change. In doing so, any carried items 8 (see FIG. 3) in the front storage tray 7 need not be removed and can stay in place. Further, to the extent any items carried in the rear storage tray 9 do not stick up too far above the tray 9, those items can also simply remain in the tray 9 regardless of the positioning of the front roof section 3 of FIGS. 1-3.

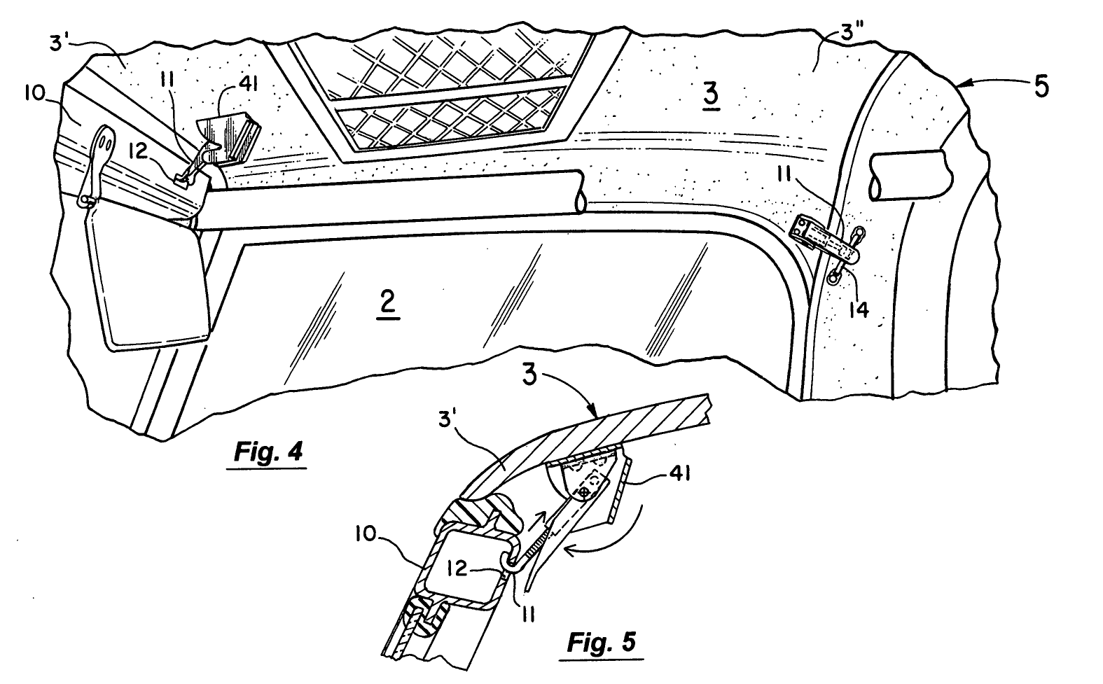

In the first position of FIG. 2 with the front roof section 3 attached over the forward area 2 of the vehicle 4, the front edge portion 3′ of the roof section 3 is releasably secured to the vehicle windshield 10 (see also FIG. 4) by one or more clamps 11. The rear edge portion 3″ in FIG. 4 is then secured to each side of the rear roof section 5 by a similar clamp 11. These clamps 11 can be of any number of designs. In the illustrated one of FIGS. 4 and 5, the forward clamp 11 is received in a slot 12 in the vehicle windshield 10 and held in place with a simple overcenter arrangement (FIG. 5). The rearward clamp 11 as illustrated in FIG. 4 is then attached to a bar or footman 14 on the rear roof section 5.

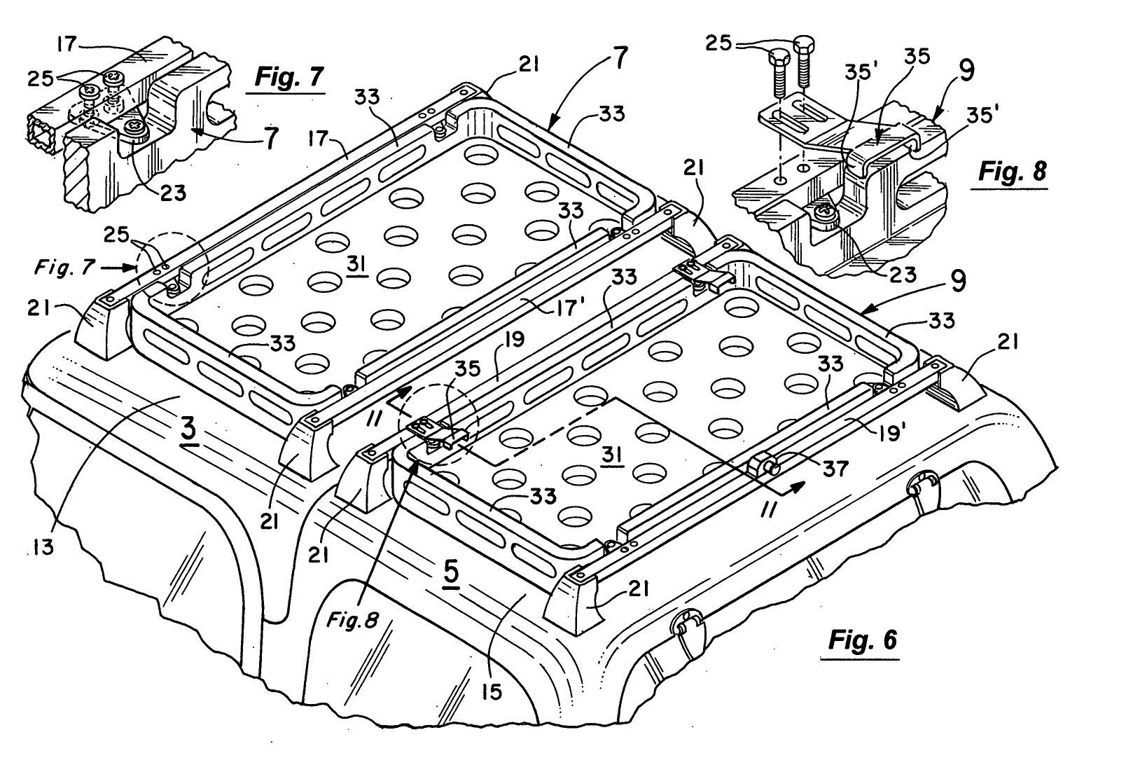

The front and rear storage trays 7 and 9 (see FIG. 6) are preferably mounted to the upper, exterior sides or surfaces 13 and 15 of the respective front and rear roof sections 3 and 5. In the illustrated manner, the trays 7 and 9 are respectively suspended between the pairs of rails 17, 17′ and 19,19′. The elongated rails 17,17′ and 19,19′ in turn are supported to extend substantially across the front and rear roof section 3, 5 by the upstanding pillar members 21. The trays 7 and 9 can be attached to the respective rails 17,17′ and 19,19′ in any number of manners including the illustrated mounting tab 23 and screws 25 of FIG. 7. The trays 7 and 9 are then preferably suspended between the respective pairs of rails 17,17′ and 19,19′ with the bottoms 31 of the trays 7,9 slightly spaced above the exterior sides or surfaces 13, 15 of the front and rear roof sections 3,5. The trays 7 and 9 are preferably identical and preferably open with the sides 33 extending upwardly from the bottoms 31. The exterior sides or surfaces 13,15 of the front and rear roof sections are preferably substantially the same size as are the trays 7 and 9 wherein the carried load can be conveniently and substantially equally divided between the trays 7 and 9.

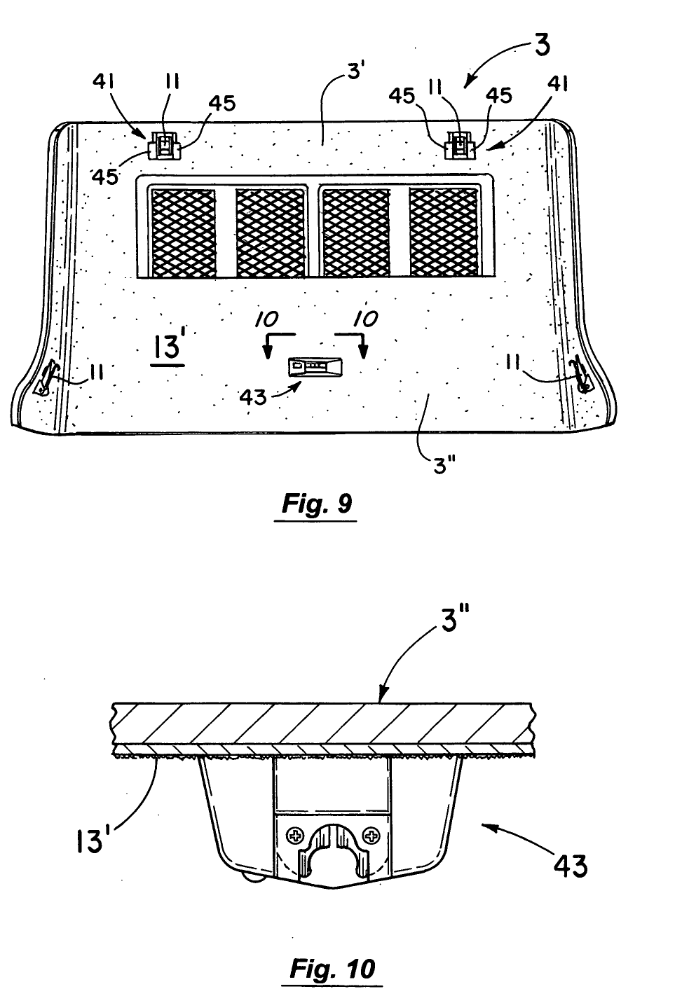

To removably attach the front roof section 3 with the tray 7 over the rear roof section 5 and rear tray 9, the rail 19 of the rear rack is additionally provided with rearwardly facing flanges 35 (see FIGS. 6 and 8) and the rail 19′ is provided with a rearwardly facing pin 37. The interior or underside 13′ of the front roof section 3 (FIG. 9) is then provided with a pair of attaching members 41 mounted on the front edge portion 31 of the front roof section 3. These attaching members 41 are releasably securable to the flanges 35 as explained in more detail below. A conventional rotary latch 43 (FIG. 10) is also provided that is centrally positioned across the interior side 13′ (FIG. 9) of the roof section 3 adjacent the rear edge portion 3″. As also explained in more detail below, the rotary latch 43 is removably securable to the pin 37 mounted on the rear rail 19′.

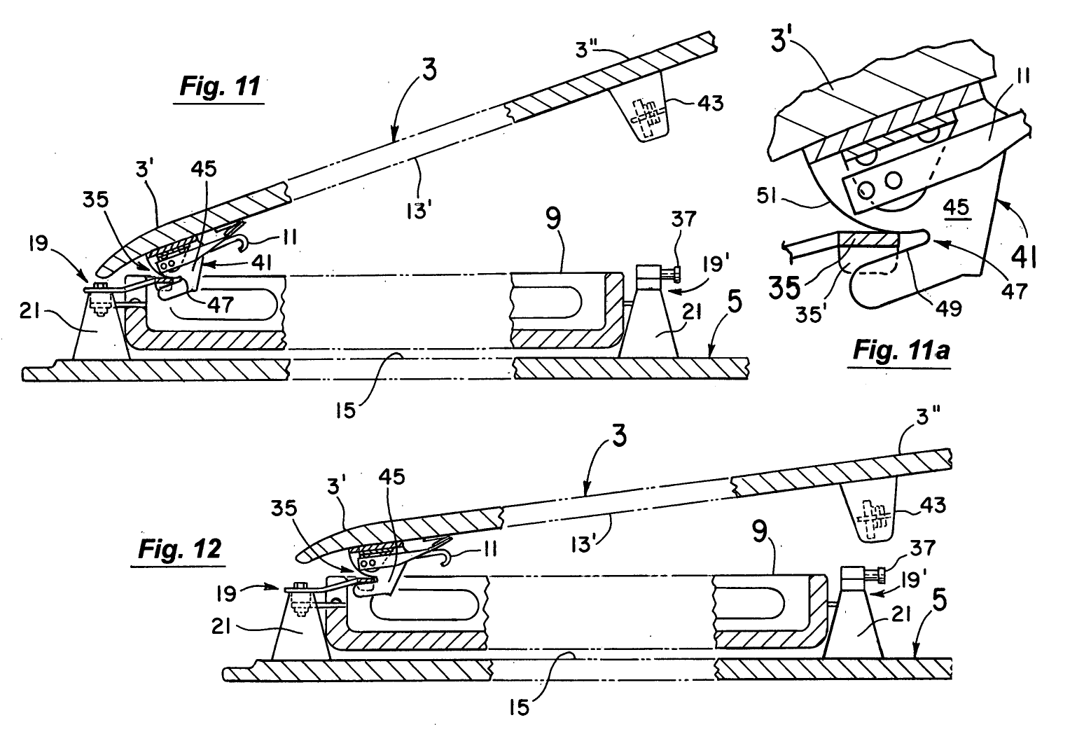

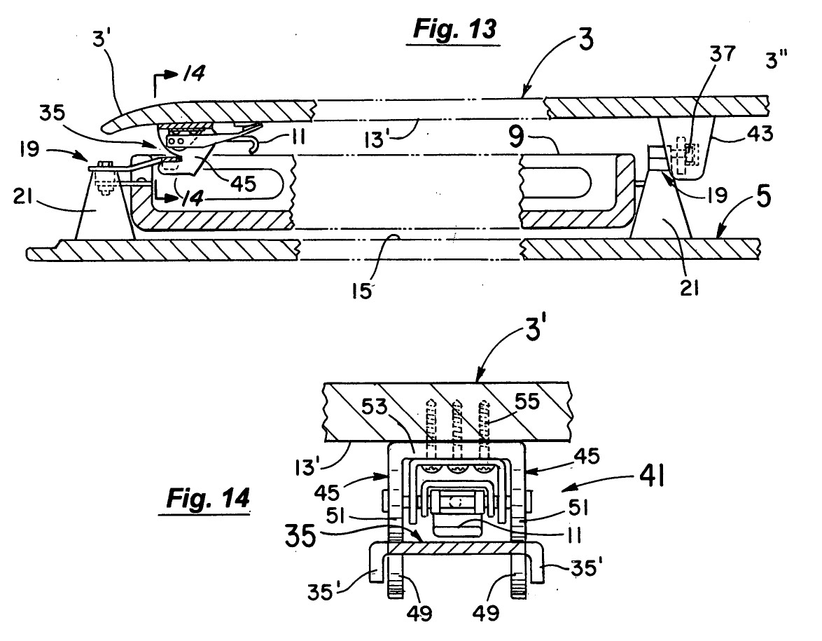

Each of the front attaching members 41 of FIG. 9 has two side pieces or arms 45 having a substantially V-shaped notch 47 therein (see FIGS. 11 and 11a). The V-shaped notch 47 preferably has a substantially straight, lower leg 49 (FIG. 11a) and a curved, upper leg 51. In this manner, the front roof section 3 can then be easily tilted as in FIG. 11 to initially receive each flange 35 in the notch 47 of each side piece 45. The section 3 can thereafter be rotated to lower the rear edge portion 3″ (FIGS. 12 and 13) to lock the latch 43 on the rearwardly extending pin 37 on the rear rail 19′ (FIG. 13). In doing so, the curved leg 51 of the V-shaped notch 47 as shown can ride or roll along the top of the flange 35 not only to help guide the flange 35 into the bottom of the notch 47 but also to help support some of the weight of the front roof section 3 during the movement of FIGS. 11-13. In the position of FIG. 13, the front roof section 3 is then securely attached in place. To further ensure this secured attachment, each flange 35 is provided with downwardly extending end segments 35′ (see FIGS. 8 and 14). As illustrated in FIG. 14, the end segments 35′ form an inverted, substantially U-shape with the horizontally extending flange 35 to thereby capture or retain the side pieces 45 and limit any lateral movement. To remove the front roof section 3, the process is simply reversed by releasing the locked rotary latch 43, rotating or tilting the front roof section 3 upwardly through the positions of FIG. 13 to FIG. 11, and moving the front roof section 3 rearwardly to disengage the flanges 35 from the notches 47 of each side piece 45. In this last regard and for increased stability, each attaching member 41 as illustrated in FIGS. 9 and 14 has two, substantially planar and vertically extending pieces 45 on each side of the clamp 11. Additionally as best seen in FIG. 14, the two side pieces 45 of each attaching member 41 are preferably joined at 53 to form an inverted, U-shaped bracket straddling the clamp 11. In this manner, the same mounting screws 55 can be used to attach the bracket pieces 45 and 53 and the clamp 11 to the underside 13′ of the roof section 3 adjacent the front edge portion 3′.

The above disclosure sets forth a number of embodiments of the present invention described in detail with respect to the accompanying drawings. Those skilled in this art will appreciate that various changes, modifications, other structural arrangements, and other embodiments could be practiced under the teachings of the present invention without departing from the scope of this invention as set forth in the following claims.

I claim:

1. A multi-piece hardtop (1) for a sport utility vehicle (4), said multi-piece hardtop having front and rear roof sections (3,5) respectively positionable over forward and rearward areas (2,6) of the vehicle, said rear roof section having a rear storage tray (9) mounted thereon, said rear storage tray having a bottom (31) and sides (33) extending upwardly therefrom, said front roof section having a front storage tray (7) mounted thereon with said front storage tray having a bottom and sides extending upwardly therefrom, said front roof section being completely removable from said vehicle and being selectively attachable in a first position to said vehicle above the forward area thereof and in a second position to said rear roof section above said rear storage tray with said front storage tray (7) stacked above said rear storage tray (9).

2. The multi-piece hardtop of claim 1 wherein said rear roof section has a rear rack with first and second rails (19,19′) spaced from one another to substantially receive said rear storage tray (9) therebetween.

3. The multi-piece hardtop of claim 2 wherein said front roof section (3) is removably attached in said second position to said first and second rails (19,19′) of said rear roof section with said front storage tray stacked above said rear storage tray.

4. The multi-piece hardtop of claim 2 wherein said first and second rails (19,19′) are elongated and extend substantially across the rear roof section.

5. The multi-piece hardtop of claim 4 wherein said rear roof section has an interior and exterior side and said rear rack further includes pillar members (21) upstanding from the exterior side (15) of said rear roof section to support said first and second rails (19,19′) spaced above said exterior side (15).

6. The multi-piece hardtop of claim 5 wherein said rear storage tray is suspended between said first and second rails and spaced above the exterior side of said rear roof section.

7. The multi-piece hardtop of claim 2 wherein said vehicle has a windshield (10) extending thereacross and said front roof section has front and rear edge portions (3′,3″), said front edge portion having at least a first pair of attaching members (11) spaced from each other across said front edge portion and respectively removably securable to said windshield and a second pair of attaching members (41) spaced from each other across said front edge portion (3′) and respectively removably securable to the first rail (19) of said rear rack.

8. The multi-piece hardtop of claim 7 wherein said front roof section has another attaching member (43) substantially centrally positioned across the front roof section adjacent the rear edge portion thereof, said another attaching member being removably securable to the second rail (19′) of said rear rack.

9. The multi-piece hardtop of claim 8 wherein said front roof section has exterior and interior sides and said first and second pairs of attaching members (11,41) and said another attaching member (43) are mounted on the interior side (13′) of said front roof section.

10. The multi-piece hardtop of claim 7 wherein said rear roof section includes at least two flanges (35) mounted on said first rail (19) and spaced from each other across said first rail a distance substantially the same as the spaced-apart second pair of attaching members (41), each attaching member of said second pair including at least one side piece (45) with a substantially V-shaped notch (47) therein, each of said flanges being receivable in the notch of the respective side pieces when said front roof section is in said second position attached to the rear roof section above said rear storage tray.

11. The multi-piece hardtop of claim 10 wherein at least one leg (51) of each V-shaped notch (47) is curved to engage and roll on the respective flange as said front roof section is moved relative to said rear roof section to said second position.

12. The multi-piece hardtop of claim 10 wherein said one side piece (45) of each attaching member (41) of said second pair is substantially planar and extends substantially vertically.

13. The multi-piece hardtop of claim 10 wherein each attaching member (41) of said second pair includes another notched side piece (45) spaced from the one side piece (45), each flange (35) being respectively receivable in the notches (47) of the two side pieces (45) of each attaching member (41) of the second pair when said front roof section is in said second position attached to the rear roof section above said rear storage tray.

14. The multi-piece hardtop of claim 13 wherein each of the first pair of attaching members (11) is a clamp.

15. The multi-piece hardtop of claim 13 wherein each flange (35) has end segments (35′) forming a substantially U-shape therewith wherein the two side pieces (45) of each attaching member (41) of the second pair is respectively receivable and retained in said U-shape.

16. The multi-piece hardtop of claim 2 wherein said front roof section has a front rack with first and second rails (17,17′) spaced from one another to substantially receive said front storage tray therebetween.

17. The multi-piece hardtop of claim 16 wherein said front and rear storage trays are substantially identical.

18. The multi-piece hardtop of claim 1 wherein said front and rear storage trays are substantially identical

19. The multi-piece hardtop of claim 1 wherein said front and rear roof sections have upper, exterior sides of substantially the same size.
